(19) United States
(12) Patent Application Publication
(10) Pub. No.: US 2015/0053138 A1
(43) Pub. Date: Feb. 26, 2015

(54) AUTOMATED PET FEEDING APPARATUS

(71) Applicants: David Ramsey, Asheville, NC (US); Laura Ramsey, Asheville, NC (US)

(72) Inventors: David Ramsey, Asheville, NC (US); Laura Ramsey, Asheville, NC (US)

(21) Appl. No.: 14/458,749

(22) Filed: Aug. 13, 2014

Related U.S. Application Data
(60) Provisional application No. 61/868,683, filed on Aug. 22, 2013.

(51) Int. Cl. A01K 5/02; H04M 1/725

(52) U.S. Cl. CPC A01K 5/02; H04M 1/72533
USPC 119/61.5

(57) ABSTRACT

There is an automatic pet food dispensing apparatus can intermittently serve wet or dry food to an animal or pet. Additionally, there is a methodology described for dispensing pet food in accordance with the automatic pet food dispensing apparatus. The apparatus has multiple input arrays for pet food containers and serving dishes. Upon prompting, by wired or wireless means, the apparatus opens a container of pet food, extracts the food to a serving dish, and then disposes of the empty container in a pet food container disposing area. The serving dish makes it way through the apparatus and out a pivoting door to the waiting pet. The apparatus has mechanical mechanisms that allow for wet pet food to be safely stored under a hermetical seal until ready for use thus preserving the health and safety of the pet, as well as preventing costly spoilage.

### CLAIM OF PRIORITY

This application claims the priority of U.S. Ser. No. 61/868,683 filed on Aug. 22, 2013, the contents of which are fully incorporated herein by reference.

### FIELD OF THE INVENTION

The field of the invention relates to automatic dispensing devices, namely devices that dispense food. In particular, to devices that automatically dispense wet pet food by opening a variety of food containers, removing the food from the food container, and disposing of the empty food container.

### BACKGROUND OF THE INVENTION

People often keep animals as pets. Some animals are kept for purely entertainment/companion purposes, whereas others are kept for sport or work. It is not unusual for a family to have multiple pets of different breeds or different species. The two most popular pet types are cats and dogs. According to recent figures by the Humane Society of America, there are about 78.2 millions dogs and about 86.4 millions cats being kept as pets in the U.S alone. As of this year, it is believed that pets outnumber children in this country four to one.

Pets are often less work and considerably less expensive than raising a child, however, pets require many of the same basic needs. The animals usually need a place to stay/sleep, food and water, to be cleaned/bathed, and have regular general healthcare. This helps to ensure that they live a long and happy life, and a severe lack of these necessities may result in criminal charges.

Some of the common reasons people don't keep pets is a lack of proper housing, lack of time to care for the animal, or a lack of ability to care for the animal when traveling or not at home for a length of time. If one is not at home intermittently during the day, the food/water must be provided solely in the morning and then when one returns in the evening. If one desires to be gone for an extended length of time, they must find another to care for the animal or board the animal at a kennel. Thus, there is a need to have a device that can supply fresh, wet food for an animal repetitiously and be able to dispose of the spent food container. This can save time and money for individuals who may need or desire to be gone from their household for a few days.

### Review of Related Technology:

U.S. Pat. No. 4,249,483 refers to a device for serving fresh moist pet food and/or water at preselected time intervals. A tray is provided which has multiple upwardly opening compartments disposed circumferentially about a central vertical axis. The compartments contain moist pet food and also water if desired. A circumferentially continuous sheet of wrapping material overlies the compartments of the tray and seals the contents in the compartments so that the contents remain fresh and moist. The compartments are serially exposed at preselected time intervals, and the wrapping material is removed from the exposed compartments as they are exposed, so that moist pet food and/or water are provided at selected intervals.

U.S. Pat. No. 4,077,360 refers to an apparatus for a single feeding of an unattended pet out of an initially hermetically sealed can of pet food. The apparatus includes an electric motor-driven can opener arranged in a housing, and a presettable timer which operates a switch to close the energization circuit for the motor at the time the feeding is to take place. The can-opening mechanism includes a cutter blade and can-turning gear combination, a vertically reciprocatable slide member supporting the cutter blade and a cam follower, and a power gear and box cam combination driven by the motor for vertically displacing the cam follower. In operation, when the motor is started to affect rotation of the gear, the cam forces the cam follower and therewith the slide member downwardly slightly, so that the cutter blade is forced through the lid of the can at the beginning of the cycle and is then held there while the can turns to sever the lid from the body of the can. At the end of the cycle, a rise in the cam raises the cam follower and the slide member to retract the cutter blade upwardly and thereby to release the can and concurrently to open the motor energization circuit. A ramp is provided below the cutter blade and turning gear combination for guiding the lidless released can to a receiving location outside the housing where the can will be accessible to the animal to be fed. This abstract is not to be taken either as a complete exposition or as a limitation of the present invention, however, the full nature and extent of the invention being discernible only by reference to and from the entire disclosure.

U.S. Pat. No. 4,044,722 refers to a disclosure directed to a timed pet food dispenser wherein a plurality of insulated and covered food containers are rigidly and removably mounted to a rotating dispensing wheel for periodic automatic dispensing of the pet food at predetermined times by gravity to a pet food pen.

U.S. Pat. No. 3,874,341 refers to a pet tending device that includes a cabinet having a spring opened door which withdraws and returns a food bowl carrying slide plate with the opening and closing of the door. A conventional alarm clock having a spring wound alarm motor with a winding shaft is mounted in the cabinet and the shaft rotates a member with the release of the alarm which retracts a latch which releasably locks the door in a closed position. The alarm motor is wound with the rotation of the retraction member in an opposite direction to permit the relocking of the door, the alarm motor shaft rotation being restricted to a predetermined amount. A closed water tank is located in the upper part of the cabinet, and its bottom is connected by a feed tube to an external trough which may be raised and lowered, and the upper part of the tank is connected to a vent tube which terminates in a downwardly directed opening at the upper part of the trough. Various accessories are associated with the cabinet.

Thus, various devices are known in the art. However, their structure and means of operation are substantially different from the present disclosure. The present disclosure enables a device to open various types of wet food containers and to dispose of the empty container. Additionally, the current device can dispense multiple containers of wet food throughout a predetermined time period. The other inventions fail to solve all the problems taught by the present disclosure as they are limited in their functionality. At least one embodiment of this invention is presented in the drawings below and will be described in more detail herein.

### SUMMARY OF THE INVENTION

An apparatus for dispensing pet food, preferably wet pet food, is described and taught having an external housing with a pivoting door with a first input array having at least one pet food container contained within the external housing; a second input array having at least one serving dish contained within the external housing; a first and a second translation apparatus wherein the first and second translation apparatus facilitate the movement of the pet food container and serving dish respectively; a multipurpose opening mechanism wherein the multipurpose opening mechanism has a cutting mechanism or a hooking mechanism and is contained within the housing; a motor operably connected to the multipurpose opening mechanism; a heated base member capable of heating the pet food and having a rotatable and vibrating element; and an extendable arm that extends moving the at least one serving dish from the external housing to a serving area through the pivoting door wherein the pivoting door has a hinge and a spring keeping the door closed when not in use making a continuous surface with the external housing.

The pet food dispensing apparatus has a heated base member. This heated base member can rotate either horizontally or vertically. This is important for proper alignment of the pet food container for opening and for proper pet food container disposal. The heated base member warms the food which serves a dual purpose. It gives the pet warm food to eat and helps to facilitate the dispensing of the food from the pet food container. There are at least two pet food container base securing members extending from the heated base member. These help to secure the pet food container during the opening and inversion processes. The pet food container is opened by a multipurpose opening mechanism having two pivoting blades on an extendable arm. One of the blades may have a hook for pulling the tabs of the container coverings. Alternatively, the multipurpose opening mechanism may comprise a hook for opening pet food containers. The arm is connected to a motor that allows for mechanical manipulation of the arm. Once the food has been opened and dispensed, the pet food container base securing members release the pet food container. The heated base member tilts backwards and disposes the empty pet food container and any other trash (i.e. pet food container lid) in the pet food container disposing area. This is a removable, sealed tray that may be reusable or thrown away and replaced as needed. Further, the pet food dispensing apparatus may have a camera capable of recording video and taking images.

Additionally, there is a method of dispensing pet food using the above described pet food dispensing apparatus having the steps of placing at least one pet food container into a first input array; placing at least one pet food serving dish into a second input array; and using a signaling apparatus to cause the pet food dispensing apparatus to perform a number of steps including moving at least one pet food container to an opening area; moving at least one pet food serving dish to the opening area; securing the base of the at least one pet food container with at least two pet food container securing members; opening the least one pet food container with a multipurpose opening mechanism; dispensing the pet food from the pet food container into the serving dish; moving the serving dish to a serving area; and disposing the pet food container in a pet food container disposing area. The method may also have the step of warming the pet food container on a heated base member.

The means of identifying which animal(s) needs to or should be fed can be determined in a number of ways. The method may permit a user to interact with a mobile application on a smart phone or other wireless or wired device. The device may also employ near field communications, radio frequency identification or infrared sensors to detect particular animals. For example, a cat's collar may have a RFID chip that allows it to receive food a particular number of times a day when the cat comes within a prescribed distance to the feeding apparatus.

It is an object of the present invention to provide a pet food dispensing apparatus that dispenses wet pet food.

It is an object of the present invention to provide a pet food dispensing apparatus that disposes empty pet food containers.

It is an object o the present invention to provide a pet food dispensing apparatus that can be operated remotely.

It is an object of the present invention to provide a pet food dispensing apparatus that can store a number of unopened, hermetically sealed pet food containers.

It is an object of the present invention to provide a pet food dispensing apparatus that empties a pet food container using heat, vibration, or shock.

It is another object of the present invention to provide a pet food dispensing apparatus that is programmable.

It is another object of the present invention to provide a pet food dispensing apparatus that can distinguish between pets and distribute pet food accordingly.

### BRIEF DESCRIPTION OF DRAWINGS

Embodiments of the present invention will now be described, by way of example only, with reference to accompanying drawings, in which:

FIG. 1 is a perspective view of a preferred embodiment of the present invention.

FIG. 2 is a side view of a preferred embodiment of the present invention with a wall of the external housing removed showing the internal components and their interactions.

FIG. 3A is a side view of the multipurpose opening mechanism cutting open a foil pouch.

FIG. 3B is a side view of the multipurpose opening mechanism lifting and pulling the tab on a container lid.

FIG. 4 is an example of a user interface for controlling the present invention.

FIG. 5 is an example of a programming menu of the present invention.

### DETAILED DESCRIPTION OF THE INVENTION

The preferred embodiments of the present invention will now be described with reference to the drawings. Identical elements in the various figures are identified, as far as possible, with the same reference numerals. Reference will now be made in detail to embodiments of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

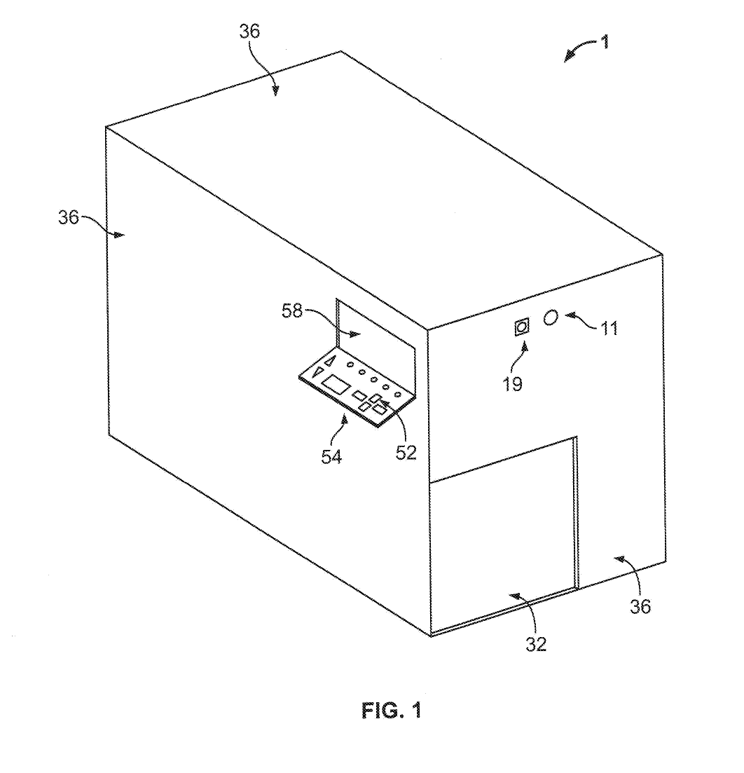

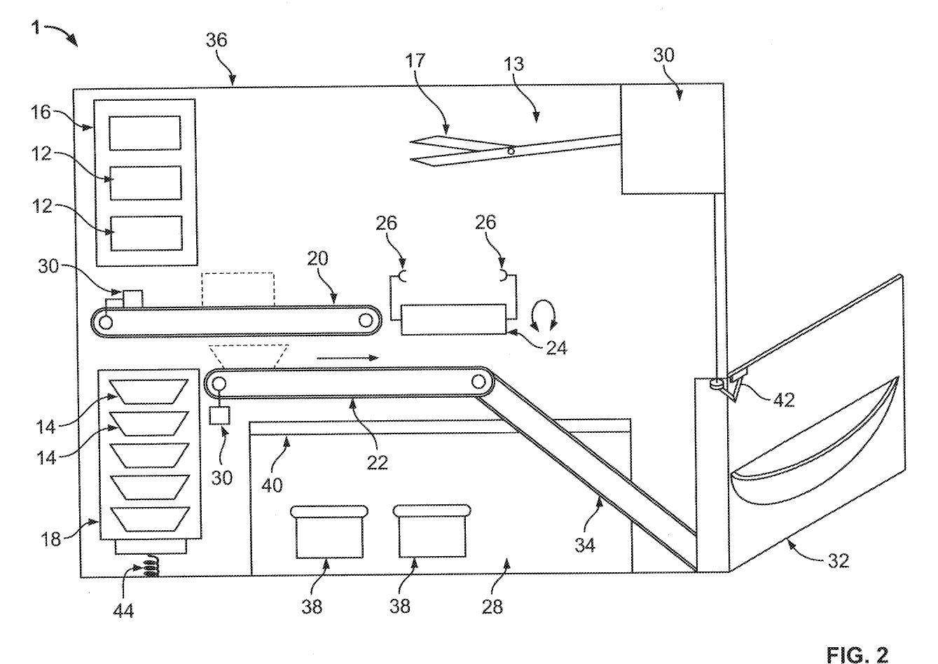

Referring to the drawings, FIG. 1 shows a perspective view of a preferred embodiment of the present invention. The pet food dispensing apparatus 1 is defined by four (4) or more planar structures coupled together forming an external housing 36. The external housing 36 is preferably rectangular in shape and has a pivoting door 32 in one of the planar structures. The pivoting door 32 is coupled to the external housing 36 by an arm 42 (see FIG. 2). The external housing 36 should be formed from a suitably hard plastic such as polyethylene terephthalate, high-density polyethylene, polyvinyl chloride, low-density polyethylene, polypropylene, and polystyrene. The external housing 36 may also be a metal, composite, or resin such as fiberglass. In the same plane as the pivoting door 32, there is an embedded camera 19 and infrared sensor 11. There is also a manual interface 54 in some embodiments that permits control over the pet food dispensing apparatus 1 on-site.

The infrared sensor 11 enables the pet dispensing apparatus 1 to activate when a pet such as a cat, wanders by looking for a meal. However, the infrared sensor 11 cannot simply be activated a number of times simultaneously. The infrared sensor 11 is tied to the programming system of the pet dispensing apparatus 1. Thus, the infrared sensor 11 will allow for a certain number of feedings in one time cycle. For example, a cat may cross the sensor at 1030 am after having eaten at 830 am. The next prescribed feeding time won't take place until at least 1230 pm and the infrared sensor 11 cannot be activated until then. The infrared sensor 11 may include, amongst others, common materials used in infrared sensors 11 such as gallium nitride, caesium nitrate, polyvinyl fluorides, phenypyridine derivatives, and cobalt phthalocyanine. In addition, the pet food dispensing apparatus 1 may have other similar capabilities such as near field communications (NFC) to dispense pet food. For example, a cat may wear a collar having NFC capabilities, and the pet food dispensing apparatus 1 will provide food at certain times when the cat comes within the predescribed proximity.

The camera 19 may be tied to the operation of the infrared sensor 11. Thus, the camera may be set to capture images or record a length of video when the sensor 11 is activated. Alternatively, the camera 19 may be independently programmable or viewable in real time. The pet owner may then be able to get snapshots or video of their pet when they are not at home. Preferably, the camera 19 should have the capabilities to capture images comprising at least 3 megapixels.

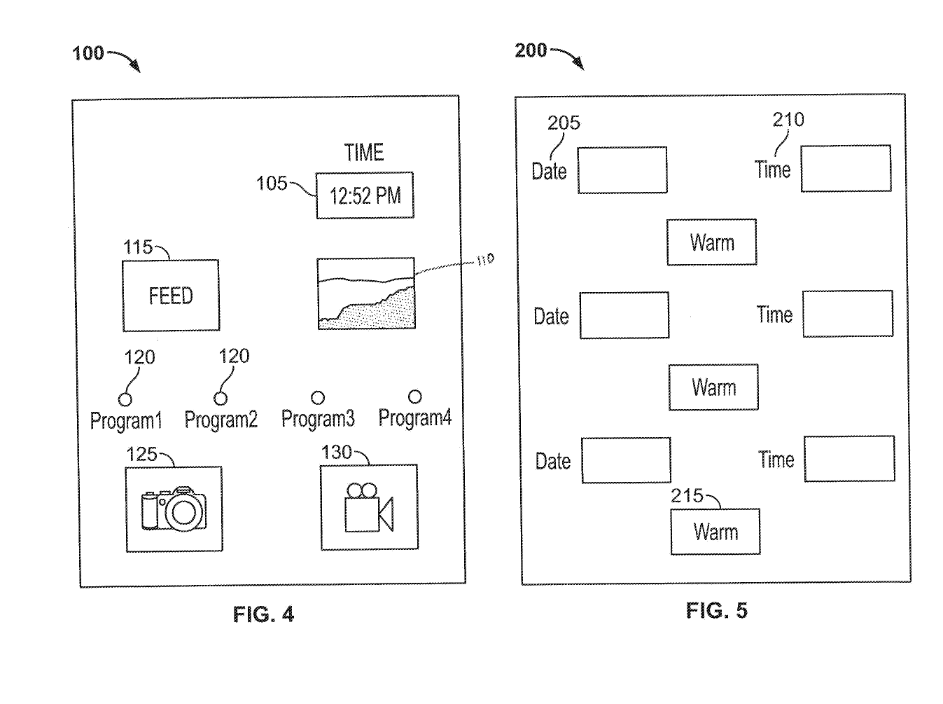

The pet food dispensing apparatus 1 may be controlled wirelessly (see FIGS. 4 & 5) through a dedicated remote control or mobile application or by the manual interface 54 embedded in the pet food dispensing apparatus 1. The manual interface 54 comprises a liquid crystal display (LCD) 58 and a flip down panel with touch sensitive buttons 52. The flip down panel may have depressible buttons or the manual interface 54 can be fully touch based. From here, the user may be able to execute a number of features such as setting feeding times, editing preset programs, setting up camera parameters, increasing/decreasing infrared sensitivity, and the like.

FIG. 2 shows the internal mechanisms of the pet food dispensing apparatus 1. Within the external housing 36 are a number of components that are interconnected in order to deliver the pet food to the pet. There is a first input array 16 and a second input array 18. The first input array 16 contains the pet food containers 12, whereas the second input array 18 contains the serving dishes 14. The pet food containers 12 drop down on to a first translation mechanism 20. This may be a conveyor belt or other means designed to transport the pet food container 12 from the first input array 16 to the heated base member 24. Here, it is secured by at least two pet food container base securing members 26. While this is happening, the serving dish 14 is being moved along a second translation means 22. As before, this may be a conveyor belt or other similar transportation means. The serving dish 14 is positioned by the second translation mechanism 22 underneath the heated base member 24. The multipurpose opening mechanism 13 opens the pet food container 12. The heated base member 24 warms the pet food container 12. The purpose of this warming is two fold. The pet food gets warmed and the warming of the food is conducive for removal of the food from the pet food container 12. The pet food is dispensed into the serving dish 14. The serving dish 14 travels down a food delivery ramp 34. The pivoting door 32 is opened by an arm 42 connected to a motor 30. The pet food is thereby removed from the pet food dispensing apparatus 1 and ready to be served to the pet.

The empty pet food container 38 is disposed by the pet food dispensing apparatus 1. The heated base member 24 pivots the opposite direction than when emptying the pet food container 12. The pet food container base securing members 26 release and the pet food container 12 falls into the pet food container disposing area 28. Here, the empty pet food containers 38 are stored for disposal. The pet food disposing area may have a lid 40 that is sealed as to prevent odors from being emitted by the pet food dispensing apparatus 1. There may be gaskets or O-rings to help provide an air tight barrier. The pet food disposing area 28 may be a removable container that can be removed periodically and cleaned for a return use. Alternatively, the pet food disposing area 28 may be a disposable container that is simply thrown away once full. The level of empty pet food containers 38 may be monitored by the pet food dispensing apparatus 1 by the number of feedings and size and type of containers.

The pet food container 12 and serving dish 14 may have additional means that keep the containers in their respective input arrays 16, 18. This may include a motorized base or base with a spring attached 44 that raise the serving dishes 14 once a serving dish 14 is removed for a feeding. The pet food containers 12 may require a mechanism such as a slidable door (not shown) to prevent jams or other issues. It may be possible to solely rely on gravity and permitting the next pet food container 12 in line to take the place of the former container. The various translation means of the pet food dispensing apparatus 1 may vary depending the type of pet food container 12 being used. It is preferable to use a slidable mechanism similar to a treadmill or conveyor belt. The slidable mechanism may require a gripping layer or other secondary mechanism to help hold the pet food container 12 in the proper position during translation.

The heated base member 24 may use heat to help in extracting the pet food from the pet food container 12, but that may not be sufficient. Depending on the type of food being served, it may be necessary to employ other methodologies. The pet food container base securing members 26 may vibrate back and forth singularly or in conjunction with the heated base member 24. A short electrical impulse may also travel through the securing members 26 or heated base member 24. The means listed above to help extract the pet food is not exhaustive and may include other not mentioned methodologies. There may also be any combination of methodologies to help achieve maximum extraction.

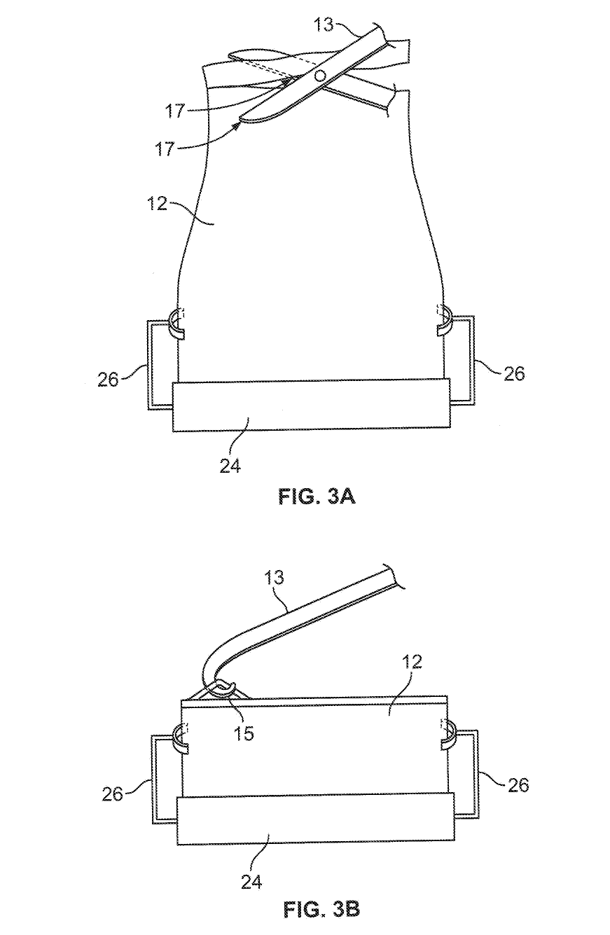

FIGS. 3A and 3B refer to the multipurpose opening mechanism 13. The form of the multipurpose opening mechanism 13 may vary depending on the intended pet food container 12 that requires opening. For foil pouches and the like, the preferred means of opening may by achieved by a pair of pivoting blades 17. These blades, much like scissors, have a hinged connection allowing them to pass by one another cutting open the pet food container 12. During this operation, the pet food container is held in place by two pet food container base securing members 26. These extensions would rise from a rested position to secure the pet food container 12. This permits the pet food container 12 to be opened without worrying of the pet food container 12 falling off the heated base member 24 or preventing a clean opening.

For pet food containers 12 with pull tabs and other lids, it is preferable to have a hook extension 15 for opening. These containers require substantially more force to open and may require an increase in the technical specifications of the pet food dispensing apparatus 1 in order to properly open the pet food container 12. Ideally, the hook extension 15 will be able to grab the tab or similar structure by either a programmed motion or by sensing the orientation of the pet food container 12. The hook extension 15 will be placed in to position (see FIG. 3B) and the motor 30 will allow the multipurpose opening mechanism 13 to pull off the top of the pet food container 12. As stated, the pet food container base securing members 26 may need supply a substantially greater force to hold the pet food container in place than if cutting/tearing open a pouch.

Most pet owners buy the same type of pet food (i.e. foil pouches, tin containers, etc.) for their pet. As such, the pet food dispensing apparatus 1 has a multipurpose opening mechanism 13 that reflects such needs. The pet food dispensing apparatus 1 may be available with only the particular multipurpose opening mechanism 13 as installed. It may be necessary that the multipurpose opening mechanism 13 is a combination of the iterations of FIGS. 3A and 3B in order to open multiple types of pet food containers 12. Additionally, the multipurpose opening mechanism 13 may be readily interchangeable. These flexibilities give pet owners the freedom to use multiple types of pet food containers 12. This would be most ideal for pet owners who have multiple animals that eat different types of food, or animals that eat different types of food throughout the day as part of a dietary program.

FIG. 4 shows a sample menu 100 from the manual interface 54 or a wireless remote. The wireless remote gives users the flexibility of changing feeding schedules and monitoring the pets from a location other than the manual interface 54. The wireless remote may be part of a dedicated receiver/transceiver system, in that the remote only works with that unit. The wireless remote may also be a smart phone, PDA, laptop, PC, gaming system or the like. Preferably, the controlling will be done from a mobile application, but may be web-based as well.

Here, the menu 100 has a number of interactive options in order to customize the user experience with the pet food dispensing apparatus 1. The following options are not inclusive and only meant to show some of the functionality of the pet food dispensing apparatus 1. The time 105 is displayed by a real time clock. The time 105 can assist a user in making scheduling choices regarding feedings based on the time of day. For example, the user may not have a preset feeding schedule and can alternatively view the time 105 and hit the manual feed 115. This would cause the pet food dispensing apparatus 1 to feed the pet at that time rather than a predetermined time. The graph 110 may be customizable to show various data such as nutritional data for the days feeding, the fullness of the pet food container disposing area 28, or feeding times from day to day. There may be a number of programming options 120 available. These permit the user to create a scheduled feeding time or pattern (see FIG. 5). There may also be a camera button 125 or recording button 130. Each of these can be used for capturing images or video recordings of the pet as they are around the pet food dispensing apparatus and feeding. The buttons 125, 130 may allow for recording and image capturing to happen at the press of the button or may take the user to another screen where this function is carried out along with enabling the user to customize other settings.

FIG. 5 is a sample of a programming menu 200 for determining feeding times and dates. Here, the user can configure the date 205 and time 210 for the pet food dispensing apparatus 1 to feed the pet. The user can pick a day or days for a pet to be fed automatically. The details are stored and can be changed as needed, or a new programmed feeding can be created. There may also be other options such as warming 215. The warming 215 feature may be needed for differing types of food based on desired serving temperature and the make up of the food. One of the functions of warming the food serves to make release come from the pet food container 12 much easier.

1. A pet food dispensing apparatus having an external housing with a pivoting door comprising:
a first input array having at least one pet food container contained within the external housing;
a second input array having at least one serving dish contained within the external housing;
a first and a second translation mechanism,
wherein the first and second translation mechanism facilitate the movement of the pet food container and serving dish respectively;
a multipurpose opening mechanism,
wherein the multipurpose opening mechanism has a cutting mechanism or a hooking mechanism or any combination thereof and is contained within the external housing;
a motor operably connected to the multipurpose opening mechanism;
a heated base member having a rotatable base and vibrating element; and
an extendable arm connected to a motor that opens the pivoting door.

2. The pet food dispensing apparatus of claim 1 wherein the cutting mechanism is two pivoting blades on an extendable arm operably connected to the motor with one of the pivoting blades having a hooked extension.

3. The pet food dispensing apparatus of claim 1 further comprising at least two pet food container base securing members extending from the heated base member.

4. The pet food dispensing apparatus of claim 1 wherein the heated base member rotates about a horizontal axis.

5. The pet food dispensing apparatus of claim 4 wherein the heated base member rotates about a vertical axis.

6. The pet food dispensing apparatus of claim 1 further comprising a camera having photographic and video capabilities.

7. The pet food dispensing apparatus of claim 1 wherein the heated base member warms the pet food and aids in pet food dispensing.

8. The pet food dispensing apparatus of claim 1 further comprising a pet food container disposing area wherein the empty pet food containers are stored until removal.

9. The pet food dispensing apparatus of claim 8 wherein the pet food container disposing area is a sealable, removable tray.

10. The pet food dispensing apparatus of claim 1 wherein the apparatus has an infrared sensor activating the apparatus when a pet is in close proximity.

11. A method of dispensing pet food using a pet food dispensing apparatus comprising:
placing at least one pet food container into a first input array;
placing at least one pet food serving dish into a second input array;
using a signaling apparatus to cause the pet food dispensing apparatus to perform a number of steps comprising,
moving at least one pet food container to an opening area;
moving at least one pet food serving dish to the opening area;
securing the base of the at least one pet food container with at least two pet food container securing members;
opening the least one pet food container with a multipurpose opening mechanism;
dispensing the pet food from the pet food container into the serving dish;
moving the serving dish to a serving area; and
disposing the pet food container in a pet food container disposing area.

12. The method of claim 11 wherein the pet food dispensing apparatus further comprises the step of:
warming the pet food in the dish on a heated base member being rotatable around a horizontal axis.

13. The method of claim 11 wherein the signaling apparatus is a wireless remote control, infrared sensor, near field communications, radio frequency identification, or the like.

14. The method of claim 13 wherein the wireless remote control is a smart phone.

15. The method of claim 13 wherein the pet wears a wireless signal transmitting device that interacts with the pet food dispensing apparatus.
